(19) United States
(12) Patent Application Publication
(10) Pub. No.: US 2025/0088865 A1
(43) Pub. Date: Mar. 13, 2025

(54) BEAM SELECTION BASED ON POWER MANAGEMENT MAXIMUM POWER REDUCTION (P-MPR) REPORT ACCORDING TO AN EVENT FROM A BODY PROXIMITY SENSOR (BPS)

(71) Applicant: Apple Inc., Cupertino, CA (US)

(72) Inventors: Yang TANG, San Jose, CA (US); Dawei ZHANG, Saratoga, CA (US); Fangli XU, Beijing (CN); Huaning NIU, San Jose, CA (US); Jie CUI, San Jose, CA (US); Manasa RAGHAVAN, Sunnyvale, CA (US); Qiming LI, Beijing (CN); Xiang CHEN, Campbell, CA (US); Yushu ZHANG, Beijing (CN)

(21) Appl. No.: 18/724,931

(22) PCT Filed: Jan. 5, 2022
(86) PCT No.: PCT/CN2022/070320

§ 371 Date: Jun. 27, 2024

(51) Int. Cl. H04W 16/28; H04B 17/318; H04W 52/36

(52) U.S. Cl. CPC H04W 16/28; H04B 17/328; H04W 52/367

(57) ABSTRACT

A user equipment including a transceiver and a processor is configured to receive, from a base station and via the transceiver, a set of resource indicators identifying a set of beams for transmission of data between the base station and the UE. The processor is also configured to perform a number of power management maximum power reduction (P-MPR) measurements for a first subset of resources, and a number of layer-1 reference signal received power (L1-RSRP) measurements for a second subset of resources. The processor is also configured to transmit, to the base station, a number of P-MPR reports and a number of L1-RSRP reports corresponding to the number of P-MPR and L1-RSRP measurements, respectively, and receive data in a downlink direction from the base station, over a beam of the set of beams at least partly in response to the number of P-MPR reports and L1-RSRP reports.

### TECHNICAL FIELD

Embodiments described herein generally relate to selection of a beam for data transmission in an uplink and/or a downlink direction based on measurement reports received from a user equipment (UE) in accordance with a human presence determined by a body proximity sensor of the UE.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE DRAWINGS

To easily identify the discussion of any particular element or act, the most significant digit or digits in a reference number refer to the figure number in which that element is first introduced.

FIG. 1 depicts an example environment in which embodiments described herein may be practiced.

FIG. 2 depicts an example message flow between a user equipment (UE) and a base station, in accordance with some embodiments.

FIG. 3 depicts an example flow chart for a beam selection process from a UE perspective, in accordance with some embodiments.

FIG. 4 depicts an example flow chart for a beam selection process from a base station perspective, in accordance with some embodiments.

FIG. 5 depicts an example flow chart describing operations of a beam selection process, in accordance with some embodiments.

FIG. 6 depicts an example architecture of a wireless communication system of a cellular carrier domain, according to embodiments disclosed herein.

FIG. 7 depicts a system for performing signaling between a UE and a network device, according to embodiments disclosed herein.

### DETAILED DESCRIPTION

Reference will now be made in detail to representative embodiments/aspects illustrated in the accompanying drawings. It should be understood that the following description is not intended to limit the embodiments to one preferred embodiment. On the contrary, it is intended to cover alternatives, modifications, and equivalents as can be included within the spirit and scope of the described embodiments as defined by the appended claims.

Embodiments described herein include methods and apparatuses (e.g., a user equipment (UE), a base station, and so on) for performing a beam selection procedure. In particular, at least one beam of a set of beams for transmission of data in an uplink and/or a downlink direction is selected according to embodiments described herein.

Data between a user equipment (UE) and a base station (e.g., a NB, an eNB, an eNodeB, a gNB, and so on) may be transmitted in an uplink and/or a downlink direction using one or more beams selected using a beam selection procedure. Transmit power at which the UE can transmit data to the base station in the uplink direction over a beam may be limited. In addition, transmit power of the UE may be reduced when a human being is detected in close proximity of the UE. The transmit power of the UE may be reduced to limit radiation exposure to the human being.

Generally, the UE transmits data in the uplink direction over a beam that is selected by the base station for transmission of data in the downlink direction by the base station. Accordingly, if the base station selects a beam for transmission of data in the downlink direction, for which the UE needs to reduce transmit power to reduce radiation exposure to a human being within a specific distance from the UE, data throughput between the UE and the base station would be reduced.

In addition, the UE may be configured to transmit data in the uplink direction at a specific transmit power only to reduce radiation exposure to a human being. However, when no human being is detected within a specific distance from the UE, still transmitting data at the transmit power that is limited to reduce radiation exposure would also reduce data throughput between the UE and the base station.

However, data throughput between the UE and the base station may be improved by using a beam selection process according to various embodiments disclosed herein. For example, when a UE detects, using a body proximity sensor (BPS), that a human being is within a specific distance from the UE, that warrants the UE to reduce transmit power for one or more beams, the UE may send a power management maximum power reduction (P-MPR) report to the base station. The UE may determine which beam of the set of beams may require reduced transmit power using the BPS. One or more beams that radiate toward the human being, or to which the human being is near the source of, may require reduced transmit power; but one or more other beams that radiate away from the human being, or to which the human being is not near the source of, may still transmit data at a higher or unreduced transmit power. The base station may perform a beam selection process based on the received P-MPR report. However, when the base station selects a beam based on the P-MPR report alone, in which the beam requiring zero or minimum transmit power reduction selected for data transmission in the uplink and/or downlink direction, it may result in a beam selection for which the UE may not receive a signal at good signal strength, and/or a beam having better beamforming gain, configured bandwidth, and/or an uplink duty cycle, and so on.

In some cases, the UE may determine that a human being has moved away from the UE and/or one or more beams by a specific distance, and the transmit power for one or more beams may thus be increased. In these cases, the UE may recalculate P-MPR and transmit to the base station one or more P-MPR reports as described herein.

In addition, the UE may report to the base station signal strength for one or more beams using layer-1 reference signal received power (L1-RSRP) measurements. However, when the base station selects a beam based on the L1-RSRP measurement report alone, in which the beam having the strongest signal strength may be selected for data transmission in the uplink and/or downlink direction, it may result in a beam selection for which the UE may be required to transmit data at a reduced transmit power.

In some cases, the transmit power for a beam may be required to be reduced for one or more reasons, for example, including but not limited to, presence of a human being within a specific distance from the UE and/or one or more beams for data transmission, link condition, data buffer status for the uplink data transmission, an uplink duty cycle for data transmission in the uplink direction, a UE specific effective and isotropically radiated power (EIRP), and so on.

Accordingly, when a beam is selected based on an L1-RSRP measurement report or a P-MPR report alone, a beam selection process may select a beam that would result in a reduced data throughput. However, as described herein in accordance with some embodiments, a beam may be selected based on a L1-RSRP measurement report and a P-MPR report corresponding to at least one beam that is identified based on a synchronization signal block (SSB) resource indicator (SSBRI) or a channel state information reference signal (CSI-RS) resource indicator (CRI). Accordingly, when a beam is selected based on a P-MPR report and an L1-RSRP report, a beam may be selected that may result in higher throughput, thereby improving network efficiency.

The base station may transmit beam configuration information identifying one or more beams for data transmission in the uplink and/or downlink direction using a set of resource indicators. The set of resource indicators may include one or more SSBRIs and/or a CRIs. The UE may generate P-MPR measurements and L1-RSRP measurements for each beam and may generate a P-MPR report and/or an L1-RSRP report that includes measurement reports and resource indicators (e.g., SSBRIs and/or CRIs, and so on) corresponding to one or more beams. The base station may consume the received P-MPR reports and L1-RSRP reports for a beam selection process.

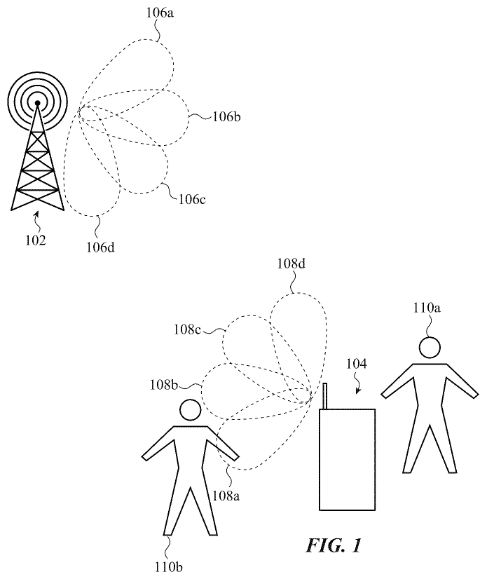

FIG. 1 depicts an example environment in which embodiments described herein may be practiced. As shown in FIG. 1, a network 100 may include a base station 102 and a UE 104. Data may be transmitted between the UE 104 and the base station 102 using one or more beams, for example, beams 106a, 106b, 106c, and/or 106d of the base station 102 and beams 108a, 108b, 108c, and/or 108d of the UE 104. As stated above, each beam may be identified by a resource indicator. The set of resource indicators may include one or more SSBRIs and/or one or more CRIs. An SSBRI and/or a CRI identifies a beam for data transmission in the uplink and/or downlink direction. For example, in an idle mode during an initial access procedure, a beam may be identified using an SSBRI, and in a connected mode, a beam may be identified using a CRI.

The base station 102 may send to the UE 104 a list of SSBRIs and/or a list of CRIs identifying a group or a set of one or more beams. By way of a non-limiting example, the list of resource indicators (including the SSBRIs and/or the CRIs) for the P-MPR report and the L1-RSRP report may include different resource indicators. However, there may be at least one resource indicator common between the list of resource indicators for the P-MPR report and the L1-RSRP report. In some embodiments, the list of resource indicators for the P-MPR report and the L1-RSRP report may be same. In some cases, the list of resource indicators for the P-MPR report may be a subset of the list of resource indicators for the L1-RSRP report.

The base station 102 may also send configuration information for sending the P-MPR reports. By way of a non-limiting example, the configuration information may be transmitted using a radio resource control configuration (RRCConfiguration) message, and may indicate to send the P-MPR reports periodically, and/or aperiodically (e.g., upon an event in which the P-MPR meets a specific criterion (e.g., when per-beam P-MPR change exceeds a specific threshold), when P-MPR change occurs for a specific number of beams, when P-MPR occurs for a beam currently used for data transmission in the uplink and/or downlink direction, and/or when there is an uplink resource for physical uplink shared channel (PUSCH) transmission, and so on). In some cases, the configuration information may indicate that the UE send a P-MPR report for a resource indicator for which an L1-RSRP report is sent to the base station 102 by the UE 104. In other words, the base station 102 may mandate the UE 104 to calculate a P-MPR report for a resource indication for which the UE 104 most recently performed and sent an L1-RSRP report. In some cases, the configuration information may indicate that the UE 104 may send the P-MPR report independently or asynchronously of the L1-RSRP report. In some embodiments, the P-MPR reporting may be according to power headroom reporting procedure as described in section 5.4.6 of 3GPP TS 38.321 Version 16.6.0 Release 16 titled “5G; NR; Media Access Control (MAC) Protocol Specification,” published in October 2021.

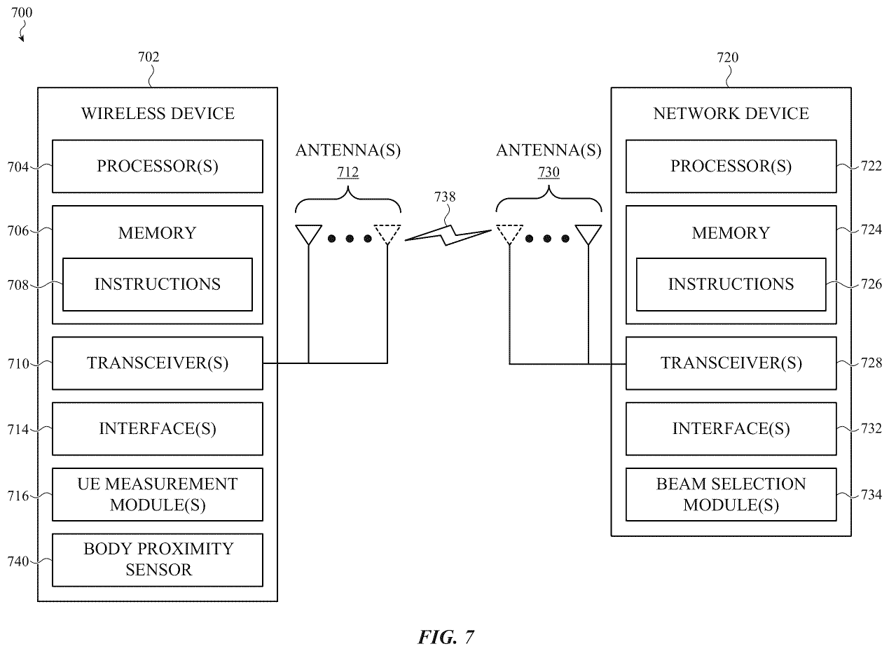

The UE may include a body proximity sensor (BPS) (shown in FIG. 7) which may be configured to detect presence and/or absence of a human being proximate to the UE. When the UE detects presence of a human being within a threshold distance of the UE, the UE may identify one or more beams of the beams 108a, 108b, 108c, and/or 108d that may require the transmit power to be reduced. The transmit power is reduced when a human being is detected within a threshold distance of the UE, so that radiation exposure for a human being may be reduced, and to meet the maximum power emission (MPE) requirement as set for the UE in the presence of a human being. By way of a non-limiting example, the transmit power for a beam is calculated and/or adjusted (e.g., increased and/or reduced) as described in 3GPP TS 38.213 Version 16.7.0 Release 16 titled “5G; NR; Physical Layer Procedure for Control,” published in October 2021. In some cases, the transmit power for a beam may be calculated and/or adjusted (e.g., increased and/or reduced) based on a virtual power control equation described in 3GPP TS 38.213 Version 16.7.0 Release 16 titled “5G; NR; Physical Layer Procedure for Control,” published in October 202.

Accordingly, when a user is at a position 110a, the BPS may determine that the user is not within a threshold distance of the UE 104, and, therefore, the UE may transmit data using one or more beams of the beams 108a, 108b, 108c, and/or 108d at a higher transmit power. But when the BPS detects the user is now at a position 110b, which is within a threshold distance of the UE and/or one or more beams of the beams 108a, 108b, 108c, and/or 108d, the UE may reduce transmit power for the one or more beams of the beams 108a, 108b, 108c, and/or 108d. The UE 104 may send one or more P-MPR reports corresponding to one or more beams to the base station 102. The UE may send the one or more P-MPR reports including one or more resource indicators identifying corresponding beams and a value corresponding to the P-MPR to the base station.

In some embodiments, the UE 104 may send the P-MPR report as a new media access control layer control element (MAC CE) to the base station 102. By way of a non-limiting example, in one MAC CE, the UE may send P-MPR reports for at least one resource indicator. For example, the UE may send P-MPR reports for four resource indicators. By way of a non-limiting example, a resource indicator in a MAC CE may be represented using a MAC CE format for power headroom report (PHR) (e.g., first two bits or Pcmax.f.c field) as described in 3GPP TS 38.321 Version 16.6.0 Release 16 titled “5G; NR; Media Access Control (MAC) Protocol Specification,” published in October 2021.

In some cases, a MAC CE for transmitting the P-MPR report may be based on a per beam reporting or per MAC entity reporting. For example, in some cases, the UE 104 may be connected to more than one cell group, and accordingly the UE 104 may have more than one MAC entity. The UE 104 may, therefore, report P-MPR for each MAC entity in the MAC CE for P-MPR reporting.

In addition, the UE 104 may also send to the base station 102 L1-RSRP measurements corresponding to the one or more beams. In other words, the UE 104 may send L1-RSRP measurements corresponding to the one or more resource indicators to the base stations 102.

As stated above, a beam may be identified or associated with a resource indicator. The base station 102 may associate the received P-MPR report and the received L1-RSRP report based on the resource indicator. Accordingly, the base station may select a beam based on an algorithm, as described herein, for data transmission in the downlink and/or uplink direction. In some cases, the base station may select a beam based on a P-MPR report for a resource indicator that is received with a specific time duration for which an L1-RSRP report is received. The specific time duration, for example, may be a couple of milliseconds (ms), for example 5 ms.

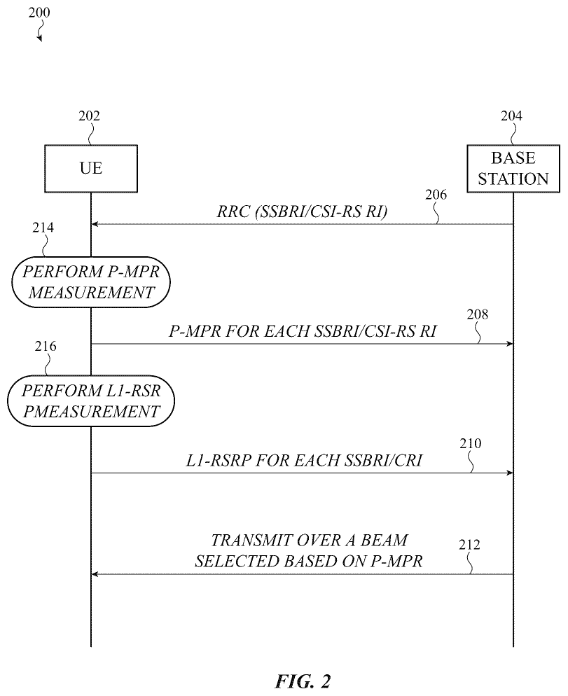

FIG. 2 depicts an example message flow between a user equipment (UE) and a base station, in accordance with some embodiments. A message flow 200 illustrates message exchanged between a UE 202 and a base station 204. As described above, the base station 204 may send to the UE 202 a list or set of resource indicators (for example, SSBRIs and/or CRIs) 206. The base station 204 may also send to the UE 202 configuration information at 206 for sending one or more P-MPR reports to the base station 204.

As described above, the configuration information sent to the UE 202 from the base station 204 may include configuration information for sending one or more P-MPR reports. By way of a non-limiting example, the configuration information may indicate to send the P-MPR reports periodically, and/or upon an event in which the P-MPR meets a specific criterion, and/or when P-MPR occurs for a specific number of beams, and/or when P-MPR occurs for a beam currently used for data transmission in the uplink and/or downlink direction.

In some cases, the configuration information may indicate that the UE 202 send a P-MPR report for a resource indicator for which an L1-RSRP report is sent to the base station 204 by the UE 202. In some cases, the configuration information may indicate that the UE 202 may send the P-MPR report independently or asynchronously of the L1-RSRP report. In some embodiments, the P-MPR reporting may be according to a power headroom reporting procedure as described in section 5.4.6 of 3GPP TS 38.321 Version 16.6.0 Release 16 titled “5G; NR; Media Access Control (MAC) Protocol Specification,” published in October 2021. In some cases, for the P-MPR reporting for a beam and/or a corresponding resource indicator, power headroom may be calculated or determined based on pathloss of the beam and/or the corresponding resource indicator.

The set of resource indicators sent to the UE 202 by the base station 204 may include one or more SSBRIs and/or one or more CRIs. An SSBRI and/or a CRI identifies a beam for data transmission in the uplink and/or downlink direction. For example, in an idle mode during an initial access procedure, a beam may be identified using an SSBRI, and in a connected mode, a beam may be identified using a CRI. Thus, the set of SSBRIs and/or CRIs may identify a group or a set of one or more beams.

By way of a non-limiting example, the base station 204 may send a first set of resource indicators (including the SSBRIs and/or the CRIs) for the P-MPR report and a second set of resource indicators for the L1-RSRP report. At least one resource indicator of the first set of resource indicators may be present in the second set of resource indicators. In some embodiments, the first set resource indicators for the P-MPR report may be a subset of the second set of resource indicators for the L1-RSRP report.

The UE 202 may perform measurements for P-MPR 214. As described above, the UE 202 may determine based on an event reported from a body proximity sensor located on the UE 202 that a human being is within a threshold distance from the UE, and transmit power of one or more beams needs to be reduced, the UE 202 may perform P-MPR measurements. As described above, the UE 202 may perform P-MPR reports periodically and/or based on occurrence of an event as described herein. The UE 202 may perform P-MPR measurements each time when L1-RSRP measurements are performed. The UE 202 may perform the P-MPR measurements and the L1-RSRP measurements for one or more resource indicators of the set of resource indicators for the P-MPR reports and the L1-RSRP reports.

The UE 202 may send a P-MPR report 208 for one or more resource indicators to the base station 204. The UE 202 may send the P-MPR report as a MAC CE to the base station 204. The MAC CE for sending the P-MPR report may report P-MPR measurements for at least one resource indicator. For example, the MAC CE may send the P-MPR report for four resource indicators. In some cases, the MAC CE may also include pathloss information for a beam associated with a resource indicator included in the MAC CE for the P-MPR report.

The UE 202 may perform L1-RSRP measurement 216 to send L1-RSRP measurements for one or more resource indicators of a set of resource indicators for L1-RSRP measurements as received from the base station 204. Even though, in FIG. 2, L1-RSRP measurements are shown performed after P-MPR measurements, the P-MPR measurements and the L1-RSRP measurements may be performed in any order. In some cases, the P-MPR measurements and the L1-RSRP measurements may be required to be performed within a specific time duration after a measurement of each other for a resource indicator. In some embodiments, by way of a non-limiting example, the specific time duration, for example, may be a couple of milliseconds (ms), for example 5 ms

The UE 202 may then send the L1-RSRP measurements 210 to the base station 204. The L1-RSRP measurements may also be sent as a MAC CE to the base station 204. The MAC CE may include L1-RSRP for at least one resource indicator. For example, the L1-RSRP measurements in the MAC CE may be for four resource indicators.

Accordingly, a MAC CE for the P-MPR report and/or the L1-RSRP report may include a P-MPR measurement and/or a L1-RSRP measurement and a corresponding resource indicator. In some cases, a MAC CE may include both a P-MPR report and a L1-RSRP report with a corresponding resource indicator.

In some cases, the UE 202 may send two L1-RSRP reports for a P-MPR report sent for a resource indicator. For example, the UE 202 may send a first L1-RSRP report for a resource indicator for which the UE measured the highest value of L1-RSRP measurement for its corresponding beam, and a second L1-RSRP report for a resource indicator for which a value calculated by subtracting a P-MPR value from a L1-RSRP for its corresponding beam is highest among similarly calculated values for other resource indicators. In some cases, different weights may be assigned to the L1-RSRP value and P-MPR value for the two L1-RSRP reports to send to the base station 204 in a MAC CE.

In some cases, if the UE 202 may determine that a resource indicator for which the UE measured the highest value of L1-RSRP measurement is same as the resource indicator for which the UE determined the value calculated by subtracting a P-MPR value from a L1-RSRP for its corresponding beam is highest among similarly calculated values for other resource indicators, the UE 202 may send only one L1-RSRP report to the base station instead of two L1-RSRP reports. As stated above, each resource indicator may be associated with a beam and thereby identify a beam.

The base station 204 may consider the received P-MPR report and/or the one or more L1-RSRP reports for selection of a beam for data transmission in the uplink and/or downlink direction 212 that may result in increased data throughput and network efficiency.

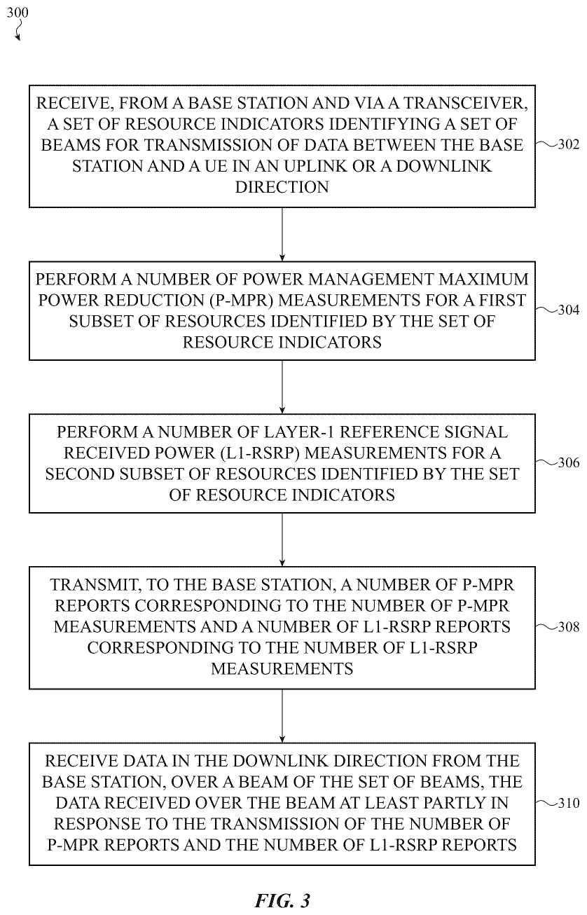

FIG. 3 depicts an example flow chart for a beam selection process from the UE perspective, in accordance with some embodiments. A flow chart 300 illustrates operations performed by a UE, for example, the UE 202, as described herein. At 302, the UE 202 may receive from the base station 204 a set of resource indicators and/or configuration for performing P-MPR measurements and sending P-MPR reports to the base station 204. As described above, the set of resource indicators may include one or more SSBRIs and/or one or more CRIs. Each resource indicator may identify a beam for data transmission in an uplink and/or a downlink direction. Since the configuration for P-MPR measurements and reports is described in detail above, it is not being repeated here again.

At 304, the UE 202 may perform P-MPR measurements as described herein. For example, the UE 202 may perform P-MPR measurements when the UE determines, using a body proximity sensor (BPS) of the UE 202, that a human being is within a threshold distance of the UE and may require transmit power reduction for one or more beams. In some cases, the UE 202 may perform P-MPR measurements periodically and/or upon performing a L1-RSRP measurement for a beam. In some cases, the UE 202 may perform the P-MPR measurements within a specific time duration after performing a L1-RSRP measurement for a beam. In some cases, the UE may perform P-MPR measurements asynchronously or independently of the L1-RSRP measurement for a beam (and its corresponding resource indicator).

As described above, the UE 202 may be sent a first subset of resource indicators of a set of resource indicators for P-MPR measurements and a second subset of resource indicators of the set of resource indicators for L1-RSRP measurements. The first subset of resource indicators and the second subset of resource indicators may have at least one resource indicator common among them. In some cases, the first subset of resource indicators may be a subset of the second subset of resource indicators. At 306, the UE 202 may perform L1-RSRP measurements as described herein. Accordingly, the UE 202 may perform P-MPR measurements at 304 and L1-RSRP measurements at 306 for one or more resource indicators of the first subset of resource indicators and the second subset of resource indicators, respectively, as described herein.

At 308, the UE 202 may send a P-MPR report and one or more L1-RSRP reports to the base station 204, as described herein. As stated above, the UE 202 may send the P-MPR report in a MAC CE to the base station. The UE 202 may also send one or more L1-RSRP reports in one or more MAC CEs. Accordingly, a MAC CE for the P-MPR report and/or the one or more L1-RSRP reports may include at least one resource indicator and its corresponding P-MPR and/or L1-RSRP measurement. In some cases, a MAC CE may include P-MPR and/or L1-RSRP measurements for more than one resource indicators, for example, four resource indicators.

In some cases, the UE 202 may be prohibited to send a P-MPR report while a prohibit timer is running. A prohibit timer is started when a P-MPR report is sent, and the UE 202 may send another P-MPR report once the prohibit timer is expired. By way of a non-limiting example, the prohibit timer may be configurable, and the prohibit timer value may be provided to the UE 202 by the base station 204.

In some cases, a prohibit timer may be associated with a beam or a resource indicator associated with the beam. In some cases, a prohibit timer may be associated with a MAC CE transmitted to the base station 204 for the P-MPR report.

In some cases, a prohibit timer may be started when a beam and/or resource indicator related P-MPR information is included in a MAC CE and/or transmitted from the UE 202 to the base station 204.

At 310, the base station 204 may determine a beam of a set of beams for data transmission in a downlink direction from the base station 204 to the UE 202. The base station 204 may select a beam based on the received one or more P-MPR reports and/or one or more L1-RSRP reports, as described herein. As described above, the base station 204 may determine a beam associated with a resource indicator for which the L1-RSRP measurement may indicate a stronger signal and the P-MPR measurement may indicate minimum transmit power reduction. In other words, the base station 204 may select a beam that may improve data throughput between the UE 202 and the base station 204 and may also improve network efficiency.

In some cases, the UE 202 may transmit data in an uplink direction over a beam that is selected by the base station 204 to transmit data in a downlink direction to the UE 202. In some cases, the base station 204 may instruct the UE 202 that a beam is to be used for data transmission in the uplink direction. The base station 204 may instruct the UE 202 via a radio resource control (RRC) signaling message.

In some embodiments, the UE 202 may perform measurements for P-MPR and L1-RSRP periodically. In some cases, the UE 202 may perform measurements for P-MPR at every first time interval and measurements for L1-RSRP at every second time interval. In some cases, the first time interval may be different from the second time interval. In some cases, the first time interval may be same as the second time interval.

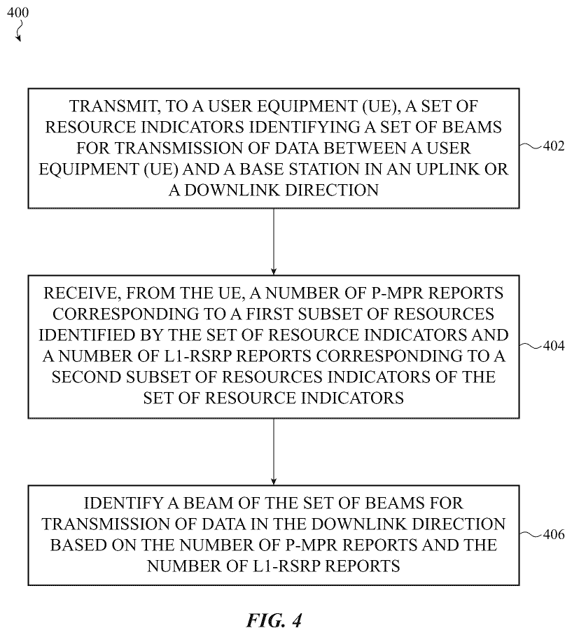

FIG. 4 depicts an example flow chart for a beam selection process from the base station perspective, in accordance with some embodiments. A flow chart 400 illustrates operations performed by a base station, for example, the base station 204, as described herein. At 402, the base station 204 may transmit to the UE 202 a set of resource indicators and/or a configuration for performing P-MPR measurements and sending P-MPR reports to the base station 204. As described above, the set of resource indicators may include one or more SSBRIs and/or one or more CRIs. Each resource indicator may identify a beam for data transmission in an uplink and/or a downlink direction. Since the configuration for P-MPR measurements and reports is described in detail above, it is not being repeated here again.

At 404, the base station 204 may receive one or more P-MPR reports and one or more L1-RSRP reports from the UE 202, as described herein. As stated above, the UE 202 may send a P-MPR report in a MAC CE to the base station 204. The UE 202 may also send one or more L1-RSRP reports in one or more MAC CEs. Accordingly, a MAC CE for the one or more P-MPR reports and/or the one or more L1-RSRP reports may include at least one resource indicator and its corresponding P-MPR and/or L1-RSRP measurement. In some cases, a MAC CE may include P-MPR and/or L1-RSRP measurements for more than one resource indicators, for example, four resource indicators.

At 406, the base station 204 may determine a beam of a set of beams for data transmission in a downlink direction from the base station 204 to the UE 202. The base station 204 may select a beam based on the received one or more P-MPR reports and/or one or more L1-RSRP reports, as described herein. As described above, the base station 204 may determine a beam associated with a resource indicator for which the L1-RSRP measurement may indicate a stronger signal and the P-MPR measurement may indicate minimum transmit power reduction. In other words, the base station 204 may select a beam that may improve data throughput between the UE 202 and the base station 204 and may also improve network efficiency.

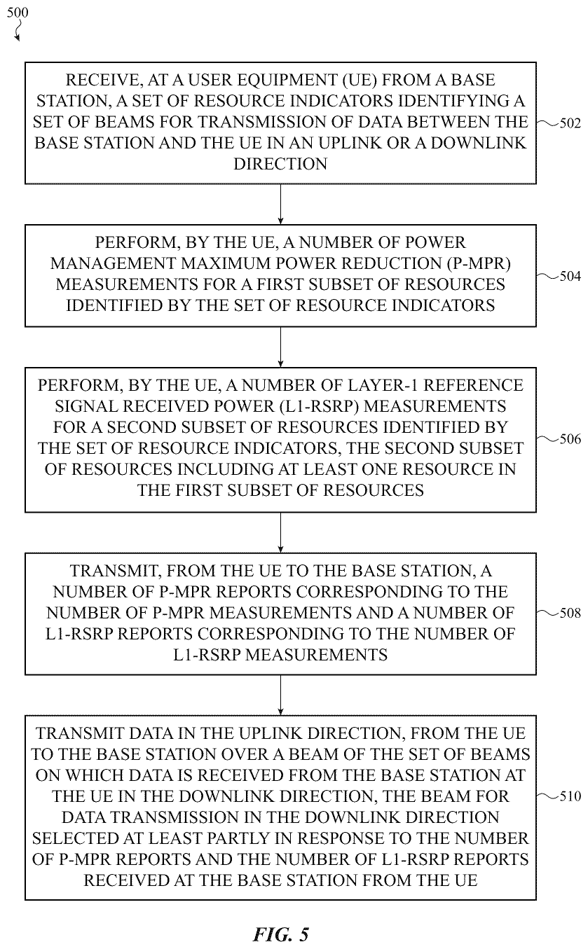

FIG. 5 depicts an example flow chat describing operations a beam selection process, in accordance with some embodiments. A flow chart 500 illustrates operations performed for a beam selection as described herein. At 502, the UE 202 may receive from the base station 204 a set of resource indicators and/or a configuration for performing P-MPR measurements and sending P-MPR reports to the base station 204. As described above, the set of resource indicators may include one or more SSBRIs and/or one or more CRIs. Each resource indicator may identify a beam for data transmission in an uplink and/or a downlink direction. Since the configuration for P-MPR measurements and reports is described in detail above, it is not being repeated here again.

At 504, the UE 202 may perform P-MPR measurements as described herein. For example, the UE 202 may perform P-MPR measurements when the UE determines using a body proximity sensor (BPS) of the UE 202 that a human being is within a threshold distance of the UE and may require transmit power reduction for one or more beams. In some cases, the UE 202 may perform P-MPR measurements periodically and/or upon performing a L1-RSRP measurement for a beam. In some cases, the UE 202 may perform the P-MPR measurements within a specific time duration after performing a L1-RSRP measurements for a beam. In some cases, the UE may perform P-MPR measurement asynchronously or independently of the L1-RSRP measurement for a beam (and its corresponding resource indicator).

As described above, the UE 202 may be sent a first subset of resource indicators of a set of resource indicators for P-MPR measurements and a second subset of resource indicators of the set of resource indicators for L1-RSRP measurements. The first subset of resource indicators and the second subset of resource indicators may have at least one resource indicator common among them. In some cases, the first subset of resource indicators may be a subset of the second subset of resource indicators. At 506, the UE 202 may perform L1-RSRP measurements as described herein. Accordingly, the UE 202 may perform P-MPR measurements at 504 and L1-RSRP measurements at 506 for one or more resource indicators of the first subset of resource indicators and the second subset of resource indicators, respectively, as described herein.

At 508, the UE 202 may send a P-MPR report and one or more L1-RSRP reports to the base station 204, as described herein. As stated above, the UE 202 may send the P-MPR report in a MAC CE to the base station. The UE 202 may also send one or more L1-RSRP reports in one or more MAC CEs. Accordingly, a MAC CE for the P-MPR report and/or the one or more L1-RSRP reports may include at least one resource indicator and its corresponding P-MPR and/or L1-RSRP measurement. In some cases, a MAC CE may include P-MPR and/or L1-RSRP measurements for more than one resource indicators, for example, four resource indicators.

In some cases, the UE 202 may be prohibited to send a P-MPR report while a prohibit timer is running. A prohibit timer is started when a P-MPR report is sent, and the UE 202 may send another P-MPR report once the prohibit timer is expired. By way of a non-limiting example, the prohibit timer may be configurable, and the prohibit timer value may be provided to the UE 202 by the base station 204.

At 510, the base station 204 may determine a beam of a set of beams for data transmission in a downlink direction from the base station 204 to the UE 202. The base station 204 may select a beam based on the received one or more P-MPR reports and/or one or more L1-RSRP reports, as described herein. As described above, the base station 204 may determine a beam associated with a resource indicator for which the L1-RSRP measurement may indicate a stronger signal and the P-MPR measurement may indicate minimum transmit power reduction. In other words, the base station 204 may select a beam that may improve data throughput between the UE 202 and the base station 204 and may also improve network efficiency.

In some cases, the UE 202 may transmit data in an uplink direction over a beam that is selected by the base station 204 to transmit data in a downlink direction to the UE 202. In some cases, the base station 204 may instruct the UE 202 a beam to be used for data transmission in the uplink direction. The base station 204 may instruct the UE 202 via a radio resource control (RRC) signaling message.

Embodiments contemplated herein include an apparatus having means to perform one or more elements of the method 300, 400, or 500. In the context of method 300, or 500, this apparatus may be, for example, an apparatus of a UE (such as a wireless device 702 that is a UE, as described herein). In the context of method 400, or 500, this apparatus may be, for example, an apparatus of an access point or a base station (such as a network device 718 that is an access point or a base station, as described herein).

Embodiments contemplated herein include one or more non-transitory computer-readable media storing instructions to cause an electronic device, upon execution of the instructions by one or more processors of the electronic device, to perform one or more elements of the method 300, 400, or 500. In the context of method 300, or 400, this non-transitory computer-readable media may be, for example, a memory of a UE (such as a memory 706 of a wireless device 702 that is a UE, as described herein). In the context of method 400, or 500, this non-transitory computer-readable media may be, for example, a memory of an access point or a base station (such as a memory 724 of a network device 718 that is an access point or a base station, as described herein).

Embodiments contemplated herein include an apparatus having logic, modules, or circuitry to perform one or more elements of the method 300, 400, or 500. In the context of method. In the context of method 300, or 400, this apparatus may be, for example, an apparatus of a UE (such as a wireless device 702 that is a UE, as described herein). In the context of method 400, or 500, this apparatus may be, for example, an apparatus of an access point or a base station (such as a network device 718 that is an access point or a base station, as described herein).

Embodiments contemplated herein include an apparatus having one or more processors and one or more computer-readable media, using or storing instructions that, when executed by the one or more processors, cause the one or more processors to perform one or more elements of the method 300, 400, or 500. In the context of method 300, or 400, this apparatus may be, for example, an apparatus of a UE (such as a wireless device 702 that is a UE, as described herein), or an apparatus of an access point or an application server (such as a network device 718 that is an access point or a base station, as described herein).

Embodiments contemplated herein include a signal as described in or related to one or more elements of the method 300, 400, or 500.

Embodiments contemplated herein include a computer program or computer program product having instructions, wherein execution of the program by a processor causes the processor to carry out one or more elements of the message flows of FIG. 2, and/or method operations of FIGS. 3-5. In the context of message flows of FIG. 2, the processor may be a processor of a UE (such as a processor(s) 704 of a wireless device 702 that is a UE, as described herein), and the instructions may be, for example, located in the processor and/or on a memory of the UE (such as a memory 706 of a wireless device 702 that is a UE, as described herein); or the processor may be a processor of an access point, or a base station in a cellular carrier domain) (such as a processor(s) 722 of a network device 720 that is a base station, or an access point, as described herein), and the instructions may be, for example, located in the processor and/or on a memory of the base station or access point (such as a memory 724 of a network device 720 that is a base station, or an access point, as described herein).

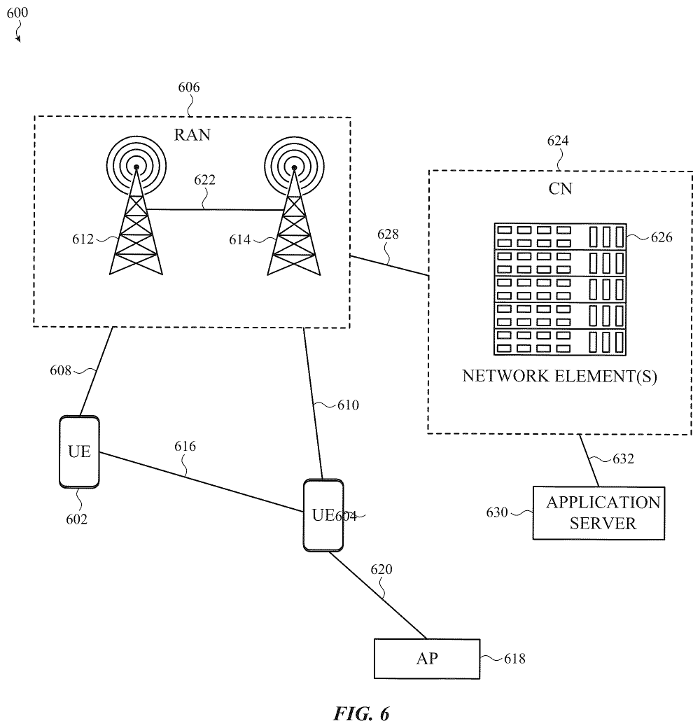

FIG. 6 depicts an example architecture of a wireless communication system of a cellular carrier domain, according to embodiments disclosed herein. The following description is provided for an example wireless communication system 600 that operates in conjunction with the LTE system standards and/or 5G or NR system standards, and/or future standards for 6G, and so on, as provided by 3GPP technical specifications.

As shown by FIG. 6, the wireless communication system 600 includes a UE 602 and a UE 604 (although any number of UEs may be used). In this example, the UE 602 and the UE 604 are illustrated as smartphones (e.g., handheld touchscreen mobile computing devices connectable to one or more cellular networks) but may also comprise any mobile or non-mobile computing device configured for wireless communication.

The UE 602 and UE 604 may be configured to communicatively couple with a RAN 606. In embodiments, the RAN 606 may be NG-RAN, E-UTRAN, etc. The UE 602 and UE 604 utilize connections (or channels) (shown as connection 608 and connection 610, respectively) with the RAN 606, each of which comprises a physical communications interface. The RAN 606 can include one or more base stations, such as base station 612 and base station 614, that enable the connection 608 and connection 610.

In this example, the connection 608 and connection 610 are air interfaces to enable such communicative coupling and may be consistent with one or more radio access technologies (RATs) used by the RAN 606, such as, for example, an LTE and/or NR.

In some embodiments, the UE 602 and UE 604 may also directly exchange communication data via a sidelink interface 616. The UE 604 is shown to be configured to access an access point (shown as AP 618) via connection 620. By way of example, the connection 620 can comprise a local wireless connection, such as a connection consistent with any IEEE 802.11 protocol, wherein the AP 618 may comprise a Wi-Fi® router. In this example, the AP 618 may be connected to another network (for example, the Internet) without going through a CN 624.

In embodiments, the UE 602 and UE 604 can be configured to communicate using orthogonal frequency division multiplexing (OFDM) communication signals with each other or with the base station 612 and/or the base station 614 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 612 or base station 614 may be implemented as one or more software entities running on server computers as part of a virtual network. In addition, or in other embodiments, the base station 612 or base station 614 may be configured to communicate with one another via interface 622. In embodiments where the wireless communication system 600 is an LTE system (e.g., when the CN 624 is an EPC), the interface 622 may be an X2 interface. The X2 interface may be defined between two or more base stations (e.g., two or more eNBs and the like) that connect to an EPC, and/or between two eNBs connecting to the EPC. In embodiments where the wireless communication system 600 is an NR system (e.g., when CN 624 is a 5GC), the interface 622 may be an Xn interface. The Xn interface is defined between two or more base stations (e.g., two or more gNBs and the like) that connect to 5GC, between a base station 612 (e.g., a gNB) connecting to 5GC and an eNB, and/or between two eNBs connecting to 5GC (e.g., CN 624).

The RAN 606 is shown to be communicatively coupled to the CN 624. The CN 624 may comprise one or more network elements 626, which are configured to offer various data and telecommunications services to customers/subscribers (e.g., users of UE 602 and UE 604) who are connected to the CN 624 via the RAN 606. The components of the CN 624 may be implemented in one physical device or separate physical devices including components to read and execute instructions from a machine-readable or computer-readable medium (e.g., a non-transitory machine-readable storage medium).

In embodiments, the CN 624 may be an EPC, and the RAN 606 may be connected with the CN 624 via an S1 interface 628. In embodiments, the S1 interface 628 may be split into two parts, an S1 user plane (S1-U) interface, which carries traffic data between the base station 612 or base station 614 and a serving gateway (S-GW), and the S1-MME interface, which is a signaling interface between the base station 612 or base station 614 and mobility management entities (MMEs).

In embodiments, the CN 624 may be a 5GC, and the RAN 606 may be connected with the CN 624 via an NG interface 628. In embodiments, the NG interface 868 may be split into two parts, an NG user plane (NG-U) interface, which carries traffic data between the base station 612 or base station 614 and a user plane function (UPF), and the SI control plane (NG-C) interface, which is a signaling interface between the base station 612 or base station 614 and access and mobility management functions (AMFs).

Generally, an application server 630 may be an element offering applications that use internet protocol (IP) bearer resources with the CN 624 (e.g., packet switched data services). The application server 630 can also be configured to support one or more communication services (e.g., VOIP sessions, group communication sessions, etc.) for the UE 602 and UE 604 via the CN 624. The application server 630 may communicate with the CN 624 through an IP communications interface 632.

FIG. 7 depicts a system for performing signaling between a UE and a network device, according to embodiments disclosed herein. FIG. A system 700 may be a portion of a wireless communications system as herein described. The wireless device 702 may be, for example, a UE of a wireless communication system. The network device 720 may be, for example, a base station or an access point connected to a wireless communication system via wired or wireless communication links.

The wireless device 702 may include one or more processor(s) 704. The processor(s) 704 may execute instructions such that various operations of the wireless device 702 are performed, as described herein. The processor(s) 704 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 702 may include a memory 706. The memory 706 may be a non-transitory computer-readable storage medium that stores instructions 708 (which may include, for example, the instructions being executed by the processor(s) 704). The instructions 708 may also be referred to as program code or a computer program. The memory 706 may also store data used by, and results computed by, the processor(s) 704.

The wireless device 702 may include one or more transceiver(s) 710 that may include radio frequency (RF) transmitter and/or receiver circuitry that use the antenna(s) 712 of the wireless device 702 to facilitate signaling (e.g., the signaling 738) to and/or from the wireless device 702 with other devices (e.g., the network device 720) according to corresponding RATs.

The wireless device 702 may include one or more antenna(s) 712 (e.g., one, two, four, or more). For embodiments with multiple antenna(s) 712, the wireless device 702 may leverage the spatial diversity of such multiple antenna(s) 712 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 702 may be accomplished according to precoding (or digital beamforming) that is applied at the wireless device 702 that multiplexes the data streams across the antenna(s) 712 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments, the wireless device 702 (e.g., a UE) may communicate with the network device 720 (e.g., a base station or an access point). The wireless device 702 may communicate with the access point via the antennas 712, and the access point may communicate with the network device 720 via a wired or wireless connection.

In certain embodiments having multiple antennas, the wireless device 702 may implement analog beamforming techniques, whereby phases of the signals sent by the antenna(s) 712 are relatively adjusted such that the (joint) transmission of the antenna(s) 712 can be directed (this is sometimes referred to as beam steering).

The wireless device 702 may include one or more interface(s) 714. The interface(s) 714 may be used to provide input to or output from the wireless device 702. For example, a wireless device 702 that is a UE may include interface(s) 714 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 710/antenna(s) 712 already described) that allow for communication between the UE and other devices and may operate according to known protocols (e.g., Wi-Fi®, Bluetooth®, and the like).

The wireless device 702 may include a UE measurement module 716 configured to perform measurement of P-MPR and L1-RSRP as described herein. The UE measurement module 716 may be implemented via hardware, software, or combinations thereof. For example, the UE measurement module 716 may be implemented as a processor, circuit, and/or instructions 708 stored in the memory 706 and executed by the processor(s) 704. In some examples, the UE measurement module 716 may be integrated within the processor(s) 704 and/or the transceiver(s) 710. For example, the UE measurement module 716 may be implemented by a combination of software components (e.g., executed by a DSP or a general processor) and hardware components (e.g., logic gates and circuitry) within the processor(s) 704 or the transceiver(s) 710.

The wireless device 702 may include one or more sensors, for example, a body proximity sensor (BPS) 740. The body proximity sensor 740 may determine presence and/or absence of a human being and report an event. Based on an event reported by the BPS 740, transmit power for one or more beams may be updated as described herein.

The network device 720 may include one or more processor(s) 722. The processor(s) 722 may execute instructions such that various operations of the network device 720 are performed, as described herein. The processor(s) 722 may include one or more baseband processors implemented using, for example, a CPU, a DSP, an ASIC, a controller, an FPGA device, another hardware device, a firmware device, or any combination thereof configured to perform the operations described herein.

The network device 720 may include a memory 724. The memory 724 may be a non-transitory computer-readable storage medium that stores instructions 726 (which may include, for example, the instructions being executed by the processor(s) 722). The instructions 726 may also be referred to as program code or a computer program. The memory 724 may also store data used by, and results computed by, the processor(s) 722.

The network device 720 may include one or more transceiver(s) 728 that may include RF transmitter and/or receiver circuitry that use the antenna(s) 730 of the network device 720 to facilitate signaling (e.g., the signaling 738) to and/or from the network device 720 with other devices (e.g., the wireless device 702) according to corresponding RATs. In certain embodiments, the signaling 738 may occur via a wired or a wireless network.

The network device 720 may include one or more antenna(s) 730 (e.g., one, two, four, or more). In embodiments having multiple antenna(s) 730, the network device 720 may perform MIMO, digital beamforming, analog beamforming, beam steering, etc., as has been described.

The network device 720 may include one or more interface(s) 732. The interface(s) 732 may be used to provide input to or output from the network device 720. For example, a network device 720 that is a base station may include interface(s) 732 made up of transmitters, receivers, and other circuitry (e.g., other than the transceiver(s) 728/antenna(s) 730 already described) that enables the base station to communicate with other equipment in a core network, and/or that enables the base station to communicate with external networks, computers, databases, and the like for purposes of operations, administration, and maintenance of the base station or other equipment operably connected thereto.

The network device 720 may include a beam selection module 734 configured to select a beam based on one or more P-MPR reports and one or more L1-RSRP reports received from the UE at the base station, as described herein. The beam selection module 734 may be implemented via hardware, software, or combinations thereof. For example, the beam selection module 734 may be implemented as a processor, circuit, and/or instructions 726 stored in the memory 724 and executed by the processor(s) 722. In some examples, the beam selection module 734 may be integrated within the processor(s) 722 and/or the transceiver(s) 728. For example, the beam selection module 734 may be implemented by a combination of software components (e.g., executed by a DSP or a general processor) and hardware components (e.g., logic gates and circuitry) within the processor(s) 722 or the transceiver(s) 728.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

As used herein, the phrase “at least one of” preceding a series of items, with the term “and” or “or” to separate any of the items, modifies the list as a whole, rather than each member of the list. The phrase “at least one of” does not require selection of at least one of each item listed; rather, the phrase allows a meaning that includes at a minimum one of any of the items, and/or at a minimum one of any combination of the items, and/or at a minimum one of each of the items. By way of example, the phrases “at least one of A, B, and C” or “at least one of A, B, or C” each refer to only A, only B, or only C; any combination of A, B, and C; and/or one or more of each of A, B, and C. Similarly, it may be appreciated that an order of elements presented for a conjunctive or disjunctive list provided herein should not be construed as limiting the disclosure to only that order provided.

What is claimed is:

1. A user equipment (UE), comprising:
a transceiver; and
a processor configured to:
receive, from a base station and via the transceiver, a set of resource indicators identifying a set of beams for transmission of data between the base station and the UE in an uplink or a downlink direction;
perform a number of power management maximum power reduction (P-MPR) measurements for a first subset of resources identified by the set of resource indicators;
perform a number of layer-1 reference signal received power (L1-RSRP) measurements for a second subset of resources identified by the set of resource indicators, the second subset of resources including at least one resource in the first subset of resources;
transmit, to the base station, a number of P-MPR reports corresponding to the number of P-MPR measurements and a number of L1-RSRP reports corresponding to the number of L1-RSRP measurements; and
receive data in the downlink direction from the base station, over a beam of the set of beams, the data received over the beam at least partly in response to the transmission of the number of P-MPR reports and the number of L1-RSRP reports.

2. The UE of claim 1, wherein the UE further comprises a body proximity sensor (BPS), and
wherein the processor is further configured to:
based on an event reported by the BPS:
recalculate the number of P-MPR measurements for the first subset of resources; and
recalculate the number of L1-RSRP measurements for the second subset of resources; and
transmit, to the base station, a P-MPR report based on the recalculated number of P-MPR measurements and an L1-RSRP report based on the recalculated number of L1-RSRP measurements.

3. The UE of claim 1, wherein the set of resource indicators comprises a set of synchronization signal block (SSB) resource indicators (SSBRIs), or channel state information reference signal (CSI-RS) resource indicators (CRIs).

4. The UE of claim 3, wherein the first subset of resources includes the set of SSBRIs and the second subset of resources includes the set of CRIs.

5. The UE of claim 1, wherein the processor is further configured to send the number of P-MPR reports or the number of L1-RSRP reports periodically.

6. The UE of claim 1, wherein the processor is further configured to: send one or more P-MPR reports of the number of P-MPR reports before or after a predetermined time period of sending one or more L1-RSRP reports of the number of L1-RSRP reports.

7. The UE of claim 1, wherein the processor is further configured to send one or more P-MPR reports of the number of P-MPR reports asynchronously or independently of one or more L1-RSRP reports of the number of L1-RSRP reports.

8. The UE of claim 1, wherein the processor is further configured to:
transmit, to the base station, the number of L1-RSRP reports including a first L1-RSRP report corresponding to a first beam of the set of beams having a highest value of the number of L1-RSRP measurements, and a second L1-RSRP report corresponding to a second beam of the set of beams having a highest value calculated using the number of L1-RSRP measurements and the number of P-MPR measurements.

9. The UE of claim 8, wherein the first beam is the same as the second beam.

10. The UE of claim 8, wherein the second L1-RSRP report corresponds to the second beam of the set of beams having the highest value that is calculated by subtracting a lowest value of the number of P-MPR measurements from the highest value of the number of L1-RSRP measurements.

11. The UE of claim 1, wherein the processor is further configured to transmit, to the base station, a P-MPR report of the number of P-MPR reports upon occurrence of an event, the event comprising: change in a P-MPR value meeting a specific criterion.

12. A base station, comprising:
a transceiver; and
a processor configured to:
transmit, to a user equipment (UE), a set of resource indicators identifying a set of beams for transmission of data between the UE and the base station in an uplink or a downlink direction;
receive, from the UE, a number of P-MPR reports corresponding to a first subset of resources identified by the set of resource indicators and a number of L1-RSRP reports corresponding to a second subset of resources of the set of resource indicators; and
identify a beam of the set of beams for transmission of data in the downlink direction based on the number of P-MPR reports and the number of L1-RSRP reports.

13. The base station of claim 12, wherein the second subset of resources comprises at least one resource indicator included in the first subset of resources.

14. The base station of claim 12, wherein a P-MPR report of the number of P-MPR reports or an L1-RSRP report of the number of L1-RSRP reports includes a resource indicator associated with a received P-MPR report or a received L1-RSRP report.

15. The base station of claim 12, wherein the processor is further configured to transmit, to the UE, at least one criteria for transmitting a P-MPR report and at least one criteria for transmitting an L1-RSRP report to the base station.

16. The base station of claim 15, wherein the at least one criteria for transmitting the P-MPR report is a first time interval and the at least one criteria for transmitting the L1-RSRP report is a second time interval.

17. The base station of claim 16, wherein the first time interval is different from the second time interval.

18. A method, comprising:
receiving, at a user equipment (UE) from a base station, a set of resource indicators identifying a set of beams for transmission of data between the base station and the UE in an uplink or a downlink direction;
performing, by the UE, a number of power management maximum power reduction (P-MPR) measurements for a first subset of resources identified by the set of resource indicators;
performing, by the UE, a number of layer-1 reference signal received power (L1-RSRP) measurements for a second subset of resources identified by the set of resource indicators, the second subset of resources including at least one resource in the first subset of resources;
transmitting, from the UE to the base station, a number of P-MPR reports corresponding to the number of P-MPR measurements and a number of L1-RSRP reports corresponding to the number of L1-RSRP measurements; and
transmitting data in the uplink direction from the UE to the base station, over a beam of the set of beams on which the data is received from the base station at the UE in the downlink direction, the beam for data transmission in the downlink direction selected at least partly in response to the number of P-MPR reports and the number of L1-RSRP reports received at the base station from the UE.

19. The method of claim 18, further comprising:
transmitting, from the UE to the base station, a P-MPR report of the number of P-MPR reports and an L1-RSRP report of the number of L1-RSRP reports periodically.

20. The method of claim 18, further comprising:
determining, by the UE, a first value that is a highest value of a L1-RSRP based on the number of L1-RSRP measurements associated with a first resource of the set of resource indicators;
determining, by the UE, a second value that is a highest value calculated by subtracting a value of a P-MPR from a value of the L1-RSRP associated with a second resource of the set of resource indicators;
transmitting, from the UE to the base station, a first L1-RSRP report associated with the first resource; and
upon determining the first resource is different from the second resource, transmitting, from the UE to the base station, a second L1-RSRP report associated with the second resource.
